(19) United States
(12) Patent Application Publication
(10) Pub. No.: US 2017/0045780 A1
(43) Pub. Date: Feb. 16, 2017

(54) DISPLAY PANEL

(71) Applicants: SHENZHEN CHINA STAR OPTOELECTRONICS TECHNOLOGY CO., LTD., GUANGDONG (CN); WUHAN CHINA STAR OPTOELECTRONICS TECHNOLOGY CO. LTD., Wuhan, Hubei (CN)

(72) Inventor: Pengbo XU, Guangdong (CN)

(21) Appl. No.: 14/890,591

(22) PCT Filed: Aug. 25, 2015
(86) PCT No.: PCT/CN2015/088010

§ 371 Date: Nov. 12, 2015

(30) Foreign Application Priority Data
Aug. 13, 2015 (CN) 201510494145.6

(51) Int. Cl. G02F 1/1335; G02F 1/1368

(52) U.S. Cl. CPC G02F 1/133621; G02F 1/133528; G02F 1/1368; G02F 1/133617; G02F 2001/133614; G02F 2202/36; G02F 2203/05

(57) ABSTRACT

A display panel is provided, and includes a first panel, a second panel, a liquid crystal layer, a backlight module and a quantum dot layer. The backlight module is configured to generate blue light. The quantum dot layer includes color block units. Red sub-color blocks and green sub-color blocks are disposed on first regions and second regions in the color block units, respectively. The red sub-color blocks and the green sub-color blocks respectively generate red light and green light under irradiation of the blue light. Third regions in the color block unit are used for the blue light to transmit therethrough. Therefore, the display quality of the display panel is improved.

### FIELD OF THE INVENTION

The present invention relates to the technical field of display, and in particular to a display panel.

### BACKGROUND OF THE INVENTION

A conventional display panel generally includes a thin film transistor array panel, a liquid crystal layer and a color film panel. The thin film transistor array panel and the color film panel are laminated into a liquid crystal cell. The liquid crystal layer is disposed inside the liquid crystal cell.

In the above conventional display panel, an electric field is applied to the liquid crystal layer through the pixel electrodes of the pixel units in the thin film transistor array panel, deflecting the liquid crystal molecules in the liquid crystal layer, so that the light reveals a corresponding color to form an image after being transmitted through the color film panel.

In practice, the inventors have found at least the following problems in the prior art:

Due to the limitations of the color film in the color film panel, it is difficult to dispose more sub-pixels in the pixel units in the thin film transistor array panel in the above conventional display panel, which is unfavorable for improving the display quality. Furthermore, in the conventional display panel, the light of the corresponding color is obtained by filtering the light through the color film, but most of the light is absorbed by the color film, causing great waste.

Therefore, it is necessary to propose a new technical solution to solve the technical problems given above.

### SUMMARY OF THE INVENTION

A primary object of the present invention is to provide a display panel which improves the display quality of the display panel.

To resolve the above problems, the technical solutions of the present invention are as follows:

A display panel is provided, and comprises: a first panel; a second panel; a liquid crystal layer in a liquid crystal cell formed by the first panel and the second panel; a backlight module provided with a blue light source, which is used for generating blue light, and for outputting blue light to the liquid crystal cell; and a quantum dot layer disposed on a surface or in an interior of one of the first panel and the second panel, wherein the quantum dot layer includes at least two color units, which are arranged in an array, and each of the color block units includes: a first region provided with a red sub-color block, which is used for generating red light under irradiation of the blue light, a second region provided with a green sub-color block, which is used for generating green light under the irradiation of the blue light, a third region, which is used for the blue light to transmit therethrough under irradiation of the blue light, wherein the red sub-color block is formed of a red quantum dot material, which is used for generating the red light under the irradiation of the blue light, wherein the green sub-color block is formed of a green quantum dot material, which is used for generating the green light under the irradiation of the blue light, wherein each of the third regions is provided with a transparent material block, which is used for the blue light to transmit therethrough under the irradiation of the blue light, wherein any one of the first region, the second region, and the third region corresponds to a sub-pixel in a pixel unit of the display panel or the pixel unit, wherein the quantum dot layer is disposed on a surface of a first polarizing plate of the first panel or a surface of a second polarizing plate of the second panel.

In the display panel, the transparent material block is formed of a transparent quantum dot material, which is used for the blue light to transmit therethrough under the irradiation of the blue light.

In the display panel, each of the color block units further comprises: a fourth region provided with a sub-color block of a first color, which is used for generating light of the first color under the irradiation of the blue light.

In the display panel, the first color is a color other than red, green and blue.

In the display panel, each of the color block units further comprises: a fifth region provided with a sub-color block of a second color, which is used for generating light of the second color under the irradiation of the blue light.

In the display panel, the second color is a color other than red, green, blue, and the first color.

A display panel is provided, and comprises; a first panel; a second panel; a liquid crystal layer in a liquid crystal cell formed by the first panel and the second panel; a backlight module provided with a blue light source, which is used for generating blue light, and for outputting blue light to the liquid crystal cell; and a quantum dot layer disposed on a surface or in an interior of one of the first panel and the second panel, wherein the quantum dot layer includes at least two color units, which are arranged in an array, and each of the color block units includes: a first region provided with a red sub-color block, which is used for generating red light under irradiation of the blue light, a second region provided with a green sub-color block, which is used for generating green light under the irradiation of the blue light, and a third region, which is used for the blue light to transmit therethrough under irradiation of the blue light.

In the display panel, the red sub-color block is formed of a red quantum dot material, which is used for generating the red light under the irradiation of the blue light, and the green sub-color block is formed of a green quantum dot material, which is used for generating the green light under the irradiation of the blue light.

In the display panel, each of the third regions on the quantum dot layer is an aperture or a hole, and the third regions are used for the blue light to transmit therethrough under the irradiation of the blue light.

In the display panel, each of the third regions is provided with a transparent material block, which is used for the blue light to transmit therethrough under the irradiation of the blue light.

In the display panel, the transparent material block is formed of a transparent quantum dot material, which is used for the blue light to transmit therethrough under the irradiation of the blue light.

In the display panel, each of the color block units further comprises: a fourth region provided with a sub-color block of a first color, which is used for generating light of the first color under the irradiation of the blue light.

In the display panel, the first color is a color other than red, green, and blue.

In the display panel, the first color is yellow.

In the display panel, each of the color block units further comprises: a fifth region provided with a sub-color block of a second color, which is used for generating light of the second color under the irradiation of the blue light.

In the display panel, the second color is a color other than red, green, blue, and the first color.

In the display panel, any one of the first region, the second region, and the third region corresponds to a sub-pixel in a pixel unit of the display panel or the pixel unit.

In the display panel, the quantum dot layer is disposed on a surface of a first polarizing plate of the first panel or a surface of a second polarizing plate of the second panel.

In the display panel, the quantum dot layer is integrated in the first panel of the second panel.

In the display panel, the first regions, the second regions, and the third regions are arranged in an array along a first direction, and the first regions, the second regions, and the third regions in the two adjacent color block units are alternately arranged along a second direction vertical with respect to the first direction.

In contrast to the prior art, the present invention improves the display quality of the display panel.

In order to make the above content of the invention clearly understood, the preferable embodiments are exemplified as follows in conjunction with the accompanying drawings and the detailed description.

### BRIEF DESCRIPTION OF THE DRAWINGS

FIG. 1 is a schematic diagram of a display panel in accordance with a first embodiment of the present invention;

FIG. 2 is a schematic diagram of a display panel in accordance with a second embodiment of the present invention;

FIG. 3 is a schematic diagram of a quantum dot layer in accordance with the first embodiment of the present invention;

FIG. 4 is a schematic diagram of a quantum dot layer in accordance with the second embodiment of the present invention;

FIG. 5 is a color gamut of a display panel in accordance with the first embodiment and the second embodiment of the present invention;

FIG. 6 is a color gamut of a display panel in accordance with a third embodiment of the present invention; and

FIG. 7 is a color gamut of a display panel in accordance with a fourth embodiment of the present invention.

### DETAILED DESCRIPTION OF THE PREFERRED EMBODIMENTS

The term “embodiment” as used in this specification means serving as an example, implementation, or illustration. Furthermore, the articles “a” or “an” as used in the specification and the appended claims may generally be construed to mean “one or more” unless it is clearly specified to be the singular form in the context.

The display panel of the present invention can be a thin film transistor liquid crystal display (TFT-LCD) or the like.

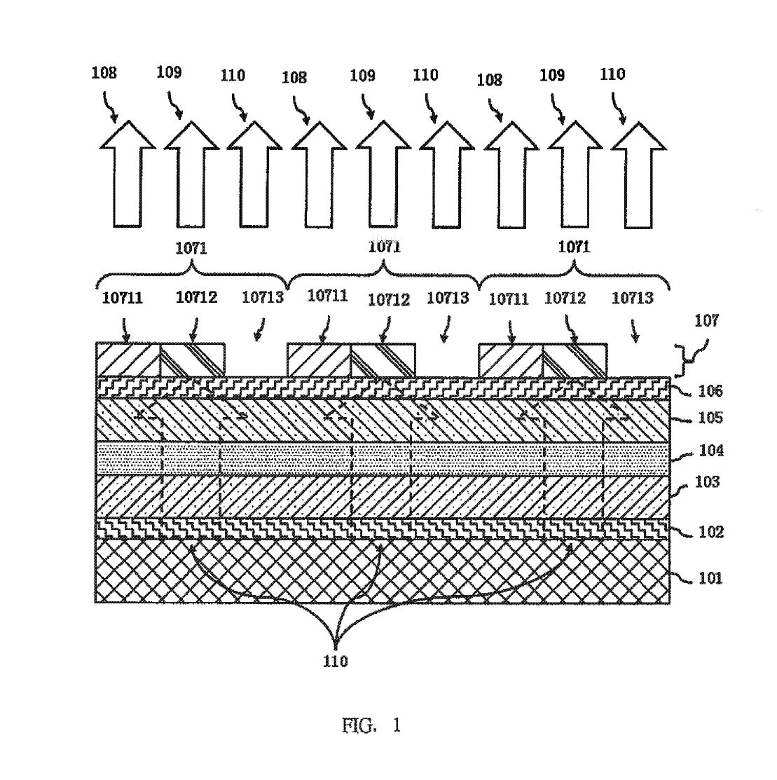

Please refer to FIG. 1, which is a schematic diagram of a display panel in accordance with a first embodiment of the present invention.

The display panel of the present embodiment includes a first panel 103, a second panel 105, a liquid crystal layer 104, a backlight module 101, and a quantum dot layer 107. The first panel 103 is a thin film transistor array panel, and the first panel 103 and/or the second panel 105 are not provided with a color film.

The liquid crystal layer 104 is disposed within a liquid crystal cell made from the first panel 103 and the second panel 105.

The backlight module 101 is provided with a blue light source, which is used for generating blue light 110, and for transmitting the blue light to the liquid crystal cell.

The quantum dot layer 107 is disposed on a surface or in an interior of any one of the first panel 103 and the second panel 105. For instance, the quantum dot layer 107 is integrated in the first panel 103 or the second inner panel 105. The quantum dot layer 107 includes at least two color block units 1071, at least the two color block units 1071 are arranged in an array along a first direction, and each of the color block units 1071 includes a first region 10711, a second region 10712, and a third region 10713.

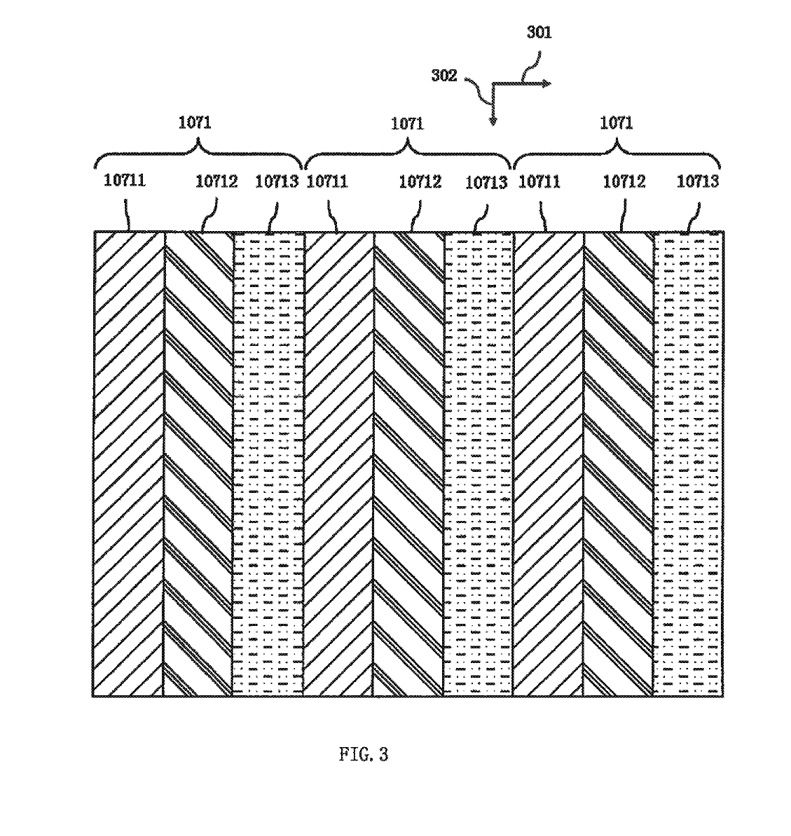

The first regions 10711, the second regions 10712, and the third regions 10713 are in elongated shapes, as shown in FIG. 3. The shape and the area of each of the first regions 10711, the second region 10712, and the third region 10713 correspond to the shape and the area of a row of pixel units (or a pixel unit row). Or the first regions 10711, the second regions 10712, and the third regions 10713 are square blocks, as shown in FIG. 4. The shape and the area of each of the first regions 10711, the second region 10712, and the third region 10713 correspond to the shape and the area of a pixel unit in the display panel.

Preferably, the shape and the area of each of the first regions 10711, the second region 10712, and the third region 10713 correspond to the shape and the area of a sub-pixel of a pixel unit in the display panel. In the present embodiment, a pixel unit includes at least three sub-pixels.

The first regions 10711, the second regions 10712, and the third regions 10713 are arranged in an array along a first direction, and the first regions 10711, the second regions 10712, and the third regions 10713 in the two adjacent color block units are alternately arranged along a second direction vertical with respect to the first direction.

Each of the first regions 10711 is provided with a red sub-color block, which is used for generating red light 108 under irradiation of the blue light 110. Each of the second regions 10712 is provided with a green sub-color block, which is used for generating green light 109 under the irradiation of the blue light 110. In the present embodiment, the third regions 10713 arc not provided with any color block, that is, each of the third regions 10713 on the quantum dot layer 107 is an aperture or a hole, and the third regions 10713 are used for the blue light 110 to transmit therethrough under the irradiation of the blue light 110.

In the present embodiment, the red sub-color block is formed of a red quantum dot material, which is used for generating the red light 108 under the irradiation of the blue light 110. The green sub-color block is formed of a green quantum dot material, which is used for generating the green light 109 under the irradiation of the blue light 110.

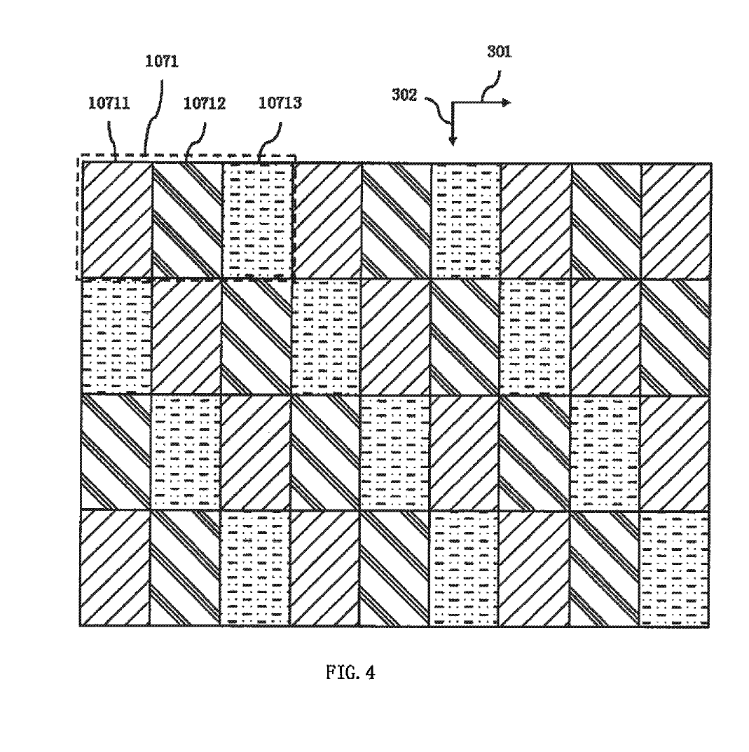

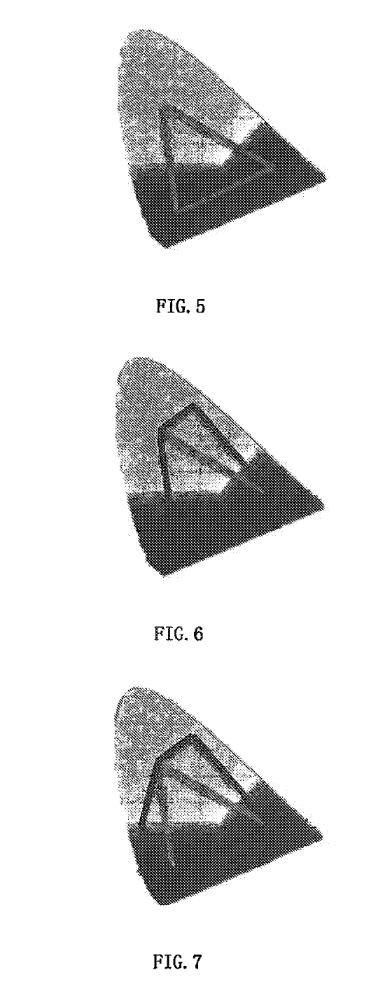

In the present embodiment, the color gamut of the display panel is as shown in FIG. 5.

In the present embodiment, any one of the first region 10711, the second region 10712, and the third region 10713 corresponds to a sub-pixel in a pixel unit of the display panel or the pixel unit.

In the present embodiment, the quantum dot layer 107 is disposed on a surface of a first polarizing plate 102 of the first panel 103 (including the surface facing the liquid crystal layer 104, or the surface facing away from the liquid crystal layer 104) or a surface of a second polarizing plate 106 of the second panel 105 (including the surface facing the liquid crystal layer 104, or the surface facing away from the liquid crystal layer 104).

Based upon the above technical solutions, the display quality of the display panel is improved.

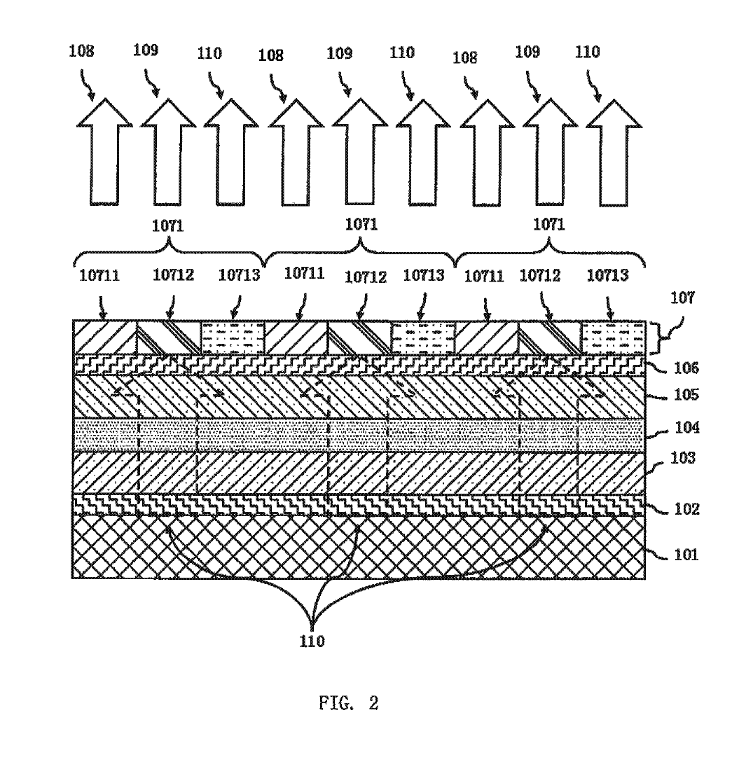

Please refer to FIG. 2, which is a schematic diagram of a display panel in accordance with a second embodiment of the present invention.

The present embodiment is similar to the aforementioned first embodiment, except that:

In the present embodiment, each of the third regions 10713 is provided with the transparent material block, that is to say, the aperture or the hole is filled with the transparent material block, which is used for the blue light 110 to transmit therethrough under the irradiation of the blue light 110. The transparent material block is formed of a transparent quantum dot material, which is used for the blue light 110 to transmit therethrough under the irradiation of the blue light 110.

In the present embodiment, the color gamut of the display panel is as shown in FIG. 5.

The third embodiment of the display panel of the present invention is similar to the aforementioned first and second embodiments, except that:

In the present embodiment, the pixel unit includes at least 4 sub-pixels. Each of the color block units 1071 further includes a fourth region. Each of the fourth regions is provided with a sub-color block of a first color, which is used for generating light of the first color under the irradiation of the blue light 110.

In the present embodiment, the first color is a color other than red, green, or blue. For example, the first color can be yellow.

In the present embodiment, the color gamut of the display panel is as shown in FIG. 6. Compared with the first embodiment, the display panel of the present embodiment has a better display quality and provides a wider color gamut.

The fourth embodiment of the display panel of the present invention is similar to the aforementioned third embodiment, except that:

In the present embodiment, the pixel unit includes at least 5 sub-pixels. Each of the color block units 1071 further includes a fifth region. Each of the fifth regions is provided with a sub-color block of a second color, which is used for generating light of the second color under the irradiation of the blue light 110.

In the present embodiment, the second color is a color other than red, green, blue, and the first color.

In the present embodiment, the color gamut of the display panel is as shown in FIG. 7. Compared with the second embodiment, the display panel of the present embodiment has a better display quality and provides a wider color gamut.

Although the present invention is described via one or more embodiments, a person of ordinary skill in the art can come up with equivalent variations and modifications based upon the understanding of the present specification and the accompanying drawings. The present invention includes all such modifications and variations, and is only limited by the scope of the appended claims. In particular, as to the various functions performed by the components described above, the terms used to describe the components are intended to correspond to any component performing the specific functions (e.g., which are functionally equivalent) of the components (unless otherwise indicated), even those which are structurally different from the disclosed structure for performing the functions in the exemplary embodiments in the present specification shown herein. In addition, although a particular feature in the present specification is disclosed in only one of many embodiments, this feature may be combined with one or more features in other embodiments which are desirable and advantageous to a given or particular application. Moreover, the terms “include”, “have”, “consist of”, or variations thereof used in the detailed description or the claims are intended to be used in a manner similar to the term “comprising”.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

What is claimed is:

1. A display panel comprising:
a first panel;
a second panel;
a liquid crystal layer in a liquid crystal cell formed by the first panel and the second panel;
a backlight module provided with a blue light source which is configured to generate blue light, and to output blue light into the liquid crystal cell; and
a quantum dot layer disposed on a surface or in an interior of one of the first panel and the second panel, wherein the quantum dot layer includes at least two color units which are arranged in an array, and each of the color block units includes:
a first region provided with a red sub-color block which is configured to generate red light under irradiation of the blue light;
a second region provided with a green sub-color block which is configured to generate green light under the irradiation of the blue light; and
wherein the red sub-color block is formed of a red quantum dot material which is configured to generate the red light under the irradiation of the blue light;
wherein the green sub-color block is formed of a green quantum dot material which is configured to generate the green light under the irradiation of the blue light;
wherein the third region is provided with a transparent material block which is used for the blue light to transmit therethrough under the irradiation of the blue light;
wherein any one of the first region, the second region and the third region corresponds to a sub-pixel in a pixel unit of the display panel or the pixel unit; and
wherein the quantum dot layer is disposed on a surface of a first polarizing plate of the first panel or a surface of a second polarizing plate of the second panel.

2. The display panel as claimed in claim 1, wherein the transparent material block is formed of a transparent quantum dot material which is used for the blue light to transmit therethrough under the irradiation of the blue light.

3. The display panel as claimed in claim 1, wherein each of the color block units further comprises:
a fourth region provided with a sub-color block of a first color which is configured to generate light of the first color under the irradiation of the blue light.

4. The display panel as claimed in claim 3, wherein the first color is a color other than red, green and blue.

5. The display panel as claimed in claim 3, wherein each of the color block units further comprises:
a fifth region provided with a sub-color block of a second color which is configured to generate light of the second color under the irradiation of the blue light.

6. The display panel as claimed in claim 5, wherein the second color is a color other than red, green, blue and the first color.

7. A display panel comprising:
a first panel;
a second panel;
a liquid crystal layer in a liquid crystal cell formed by the first panel and the second panel;
a backlight module provided with a blue light source which is configured to generate blue light, and to output blue light into the liquid crystal cell; and
a quantum dot layer disposed on a surface or in an interior of one of the first panel and the second panel, wherein the quantum dot layer includes at least two color units which are arranged in an array, and each of the color block units includes:
a first region provided with a red sub-color block which is configured to generate red light under irradiation of the blue light;
a second region provided with a green sub-color block which is used for generating green light under the irradiation of the blue light; and
a third region through which the blue light transmits under irradiation of the blue light.

8. The display panel as claimed in claim 7, wherein the red sub-color block is formed of a red quantum dot material which is configured to generate the red light under the irradiation of the blue light, and the green sub-color block is formed of a green quantum dot material which is configured to generate the green light under the irradiation of the blue light.

9. The display panel as claimed in claim 8, wherein the third region on the quantum dot layer is an aperture or a hole, and the third region is used for the blue light to transmit therethrough under the irradiation of the blue light.

10. The display panel as claimed in claim 8, wherein the third region is provided with a transparent material block which is used for the blue light to transmit therethrough under the irradiation of the blue light.

11. The display panel as claimed in claim 10, wherein the transparent material block is formed of a transparent quantum dot material which is used for the blue light to transmit therethrough under the irradiation of the blue light.

12. The display panel as claimed in claim 10, wherein each of the color block units further comprises:
a fourth region provided with a sub-color block of a first color which is configured to generate light of the first color under the irradiation of the blue light.

13. The display panel as claimed in claim 12, wherein the first color is a color other than red, green and blue.

14. The display panel as claimed in claim 13, wherein the first color is yellow.

15. The display panel as claimed in claim 12, wherein each of the color block units further comprises:
a fifth region provided with a sub-color block of a second color which is configured to generate light of the second color under the irradiation of the blue light.

16. The display panel as claimed in claim 15, wherein the second color is a color other than red, green, blue and the first color.

17. The display panel as claimed in claim 7, wherein any one of the first region, the second region and the third region corresponds to a sub-pixel in a pixel unit of the display panel or the pixel unit.

18. The display panel as claimed in claim 7, wherein the quantum dot layer is disposed on a surface of a first polarizing plate of the first panel or a surface of a second polarizing plate of the second panel.

19. The display panel as claimed in claim 7, wherein the quantum dot layer is integrated in the first panel of the second panel.

20. The display panel as claimed in claim 7, wherein the first region, the second region and the third region are arranged in an array along a first direction, and the first regions, the second regions, and the third regions in the two adjacent color block units are alternately arranged along a second direction vertical with respect to the first direction.
